(19) United States
(12) Patent Application Publication
(10) Pub. No.: US 2011/0253542 A1
(43) Pub. Date: Oct. 20, 2011

(54) STATIC ELECTROMAGNETIC APPARATUS FOR ACCELERATING ELECTRICALLY NEUTRAL MOLECULES UTILIZING THEIR DIPOLAR ELECTRIC MOMENT

(75) Inventor: Achille Zanzucchi, Torrile (IT)

(73) Assignee: ACHILLE ZANZUCCHI EDITORE DI ACHILLE ZANZUCCHI, 43056 Torrile (Parma) (IT)

(21) Appl. No.: 13/129,346

(22) PCT Filed: Nov. 13, 2009
(86) PCT No.: PCT/IT09/00515

§ 371 Date: May 13, 2011

(30) Foreign Application Priority Data
Nov. 17, 2008 (IT) PR2008A000077
Nov. 9, 2009 (IT) PR2009A000090

(51) Int. Cl. B03C 1/023; C02F 1/48; H02K 44/06

(52) U.S. Cl. 204/660; 417/50; 96/2

(57) ABSTRACT

An electromagnetic device for accelerating electrically neutral molecules of a substance is characterized by the fact of comprising: a Treating Tube (14) in non-conducting material, into which the substance to treat is introduced; static electromagnetic circuits that surround the above Treating Tube exerting on the substance to treat electromagnetic actions which push it axially, with utilization of the dipolar electric moment of the molecules. The treating method of the molecules accelerates these molecules utilizing their weak dipolar electric moment, subjecting them to a combination of a magnetic field and an electric one or, in alternative, of a magnetic field and one at Hertz waves, alternating and isofrequential, utilizing the Lorentz force of electrology.

The present invention has as object a mechanically static electromagnetic apparatus for accelerating electrically neutral molecules utilizing their weak dipolar electric moment and the Lorentz force of electrology.

The apparatus finds employment as:

a) pump for liquids,
b) compressor for gases,
c) propeller for solid substances (in pieces, powder or suspension in liquids)
d) rotatory electric motor without electric connections between stator and rotor,
e) generator of electricity fed by fluids under pressure,
f) flow indicator for fluids,
g) separator of chemical components in liquid or gas phase,
h) separator of isotopes of atoms.

The electromagnetic device object of the present patent has two main groups of applications: as motor/generator and as separator of chemical-physical components.
1) For the first group of applications, in the present technique it is resorted, generally, for the propulsion of fluids, to a combination [rotatory electric motor-centrifugal pump] in the case of motors and to another [turbine-rotatory electric motor] in the case of generators of electric energy. There are evident the disadvantages connected to the presence in the apparatuses of mobile parts, of sliding or rolling contacts, of seal surface for fluids (even corrosive and sometimes very dangerous, as those treated in the nuclear power stations) and, altogether, to the employment of apparatuses complicated and in many cases encumbering, with low energetic yields mainly due to the necessity of transforming a rotatory motion into a linear one and vice-versa.
2) For the second group of applications the separation of components with physical methods (excluding that with chemical methods) is made, in the present technique, mainly through the complex and sometimes very expensive process of fractional destillation of chemical-physical components in liquid phase, with previous liquefaction of the start mixture, if in gas form. The destillation is made in columns, generally at trays, utilizing the difference between the boiling points of the same components. The separation by means of centrifuges is employed only in some cases, as for the isotopes of uranium. Let's take into consideration, for example, the separation by destillation of a mixture of the two hydrocarbons propane and propylene in a tray column. In correspondence of an intermediate tray the feed is introduced. From the top tray it is extracted in vapour phase the more volatile component (propylene), which is condensed. A part of the condensate is re-introduced into the top plate as “reflux”, and this can be in quantity even by several times greater than that of the useful part extracted. From the bottom tray, in correspondence of which the heat for the evaporation of the liquid is supplied, the less volatile component (propane) is extracted. For one ton of mixture it can be necessary to evaporate even several tons of liquid. In the column a tray is an “enrichment element” in the more volatile component. This enrichment is obtained by creating in the tray a chemical-physical equilibrium between a liquid phase and a gas one, in which the concentration of the more volatile component in the vapour is higher than that in the liquid.

The physical principle basis of the present invention allows also to realize a new type of rotatory electric motor.

In this context, the aim of the present invention is that of proposing a very innovative electromagnetic device that can allow for the above applications great simplifications and savings in costs.

The device in question, comprising the characteristics shown in one or more of the attached Claims, allows to obtain good results in attaining such aim, above all for the presence exclusively of static parts and for the direct linear acceleration of the substances to treat without the necessity of transforming a rotatory motion into a linear one or vice-versa.

The characteristics and the advantages of the present invention will appear more clear from the indicative, and therefore not limiting, description of two forms of realization, preferred but not exclusive, of the device in question, as propeller and as separator of components, according to what shown in the attached drawings, in which:

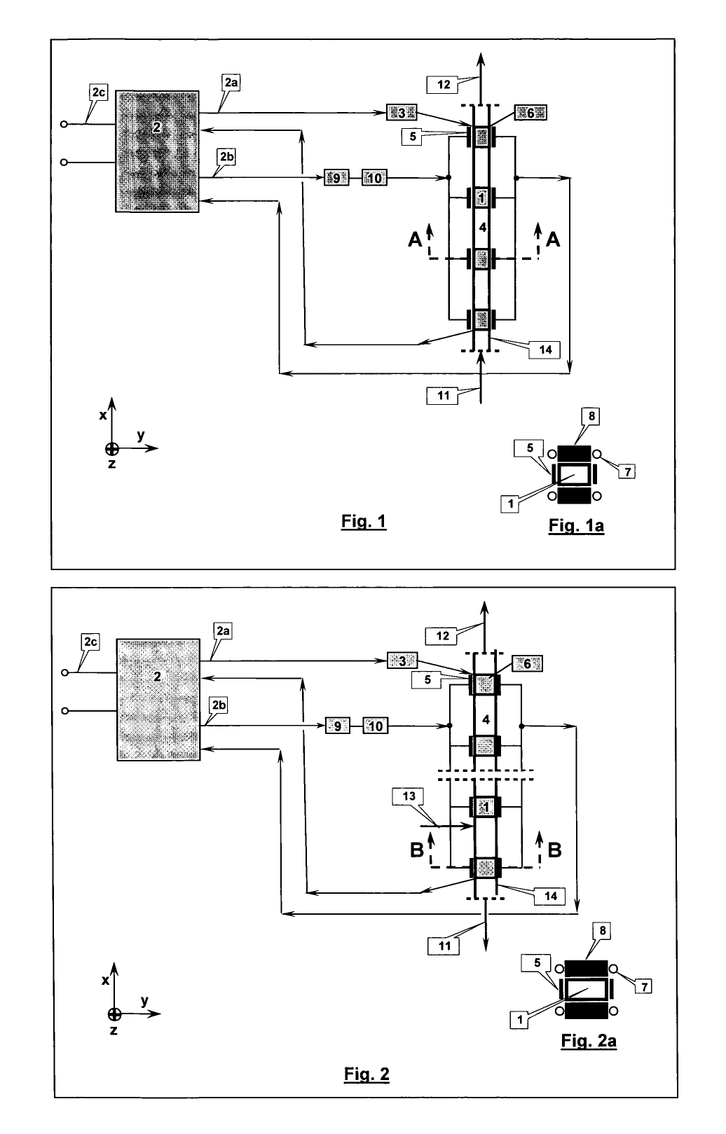

FIG. 1 shows a propeller (pump for liquids);

FIG. 1a shows section A-A of FIG. 1;

FIG. 2 shows a separator of chemical components;

FIG. 2a shows section B-B of FIG. 2;

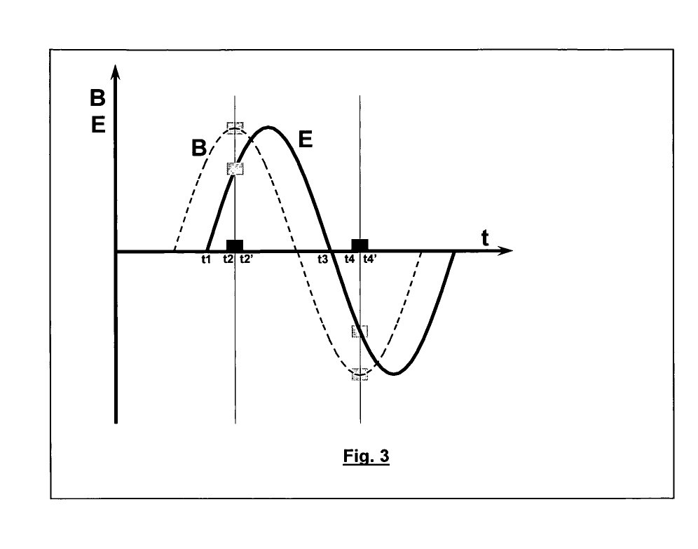

FIG. 3 shows wave forms of the vector electric field strength E and of the vector magnetic induction B;

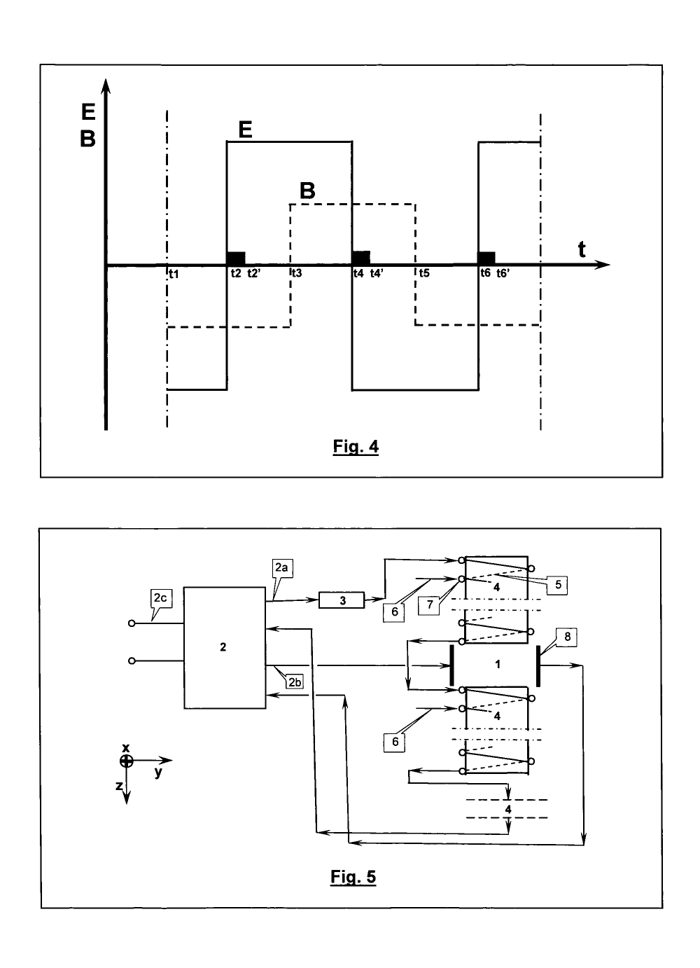

FIG. 4 shows wave forms of the vector electric field strength E and of the vector magnetic induction B in a realization variant with rectangular waves;

FIG. 5 shows an apparatus corresponding to that of FIG. 1 in a different realization form.

The principle of operation at the basis of the present invention is described in the following.

As is known, the phenomenon of the production, in an atom or a molecule, of a dipolar electric moment is called electric polarization. Such polarization can be spontaneous (caused by internal interactions in a multiatomic molecule between the positive electric charges and the negative ones), induced (by external electromagnetic fields), or combined between the two previous types.

The types of electric polarization, already described in the specific literature, are the molecular, electronic, atomic and interfacial (or ionic) polarizations.

It is known that in a (monoatomic or multiatomic) molecule the center-of-mass of the positive electric charges (atom nuclei) and that of the negative ones (peripheral orbital electrons of the atoms) can be non-coincident, due to phenomenon either intrinsic relating to the structure of a multiatomic molecule or induced by an external electric field. The product of the value of the total positive charge of the molecule by the distance between the centers-of-mass of the positive and negative charges forms a dipolar electric moment.

The behaviour of the molecule under the action of an external electric field due to the effect of the dipolar electric moment can be schematized as that of the complex of an electron (“equivalent electron”) and a positron both solid with the same molecule, lying along the axis connecting the centers-of-mass of the positive and negative electric charges, and separated by an “equivalent arm of dipolar moment” [δ].

Indicating with [e] the electric charge, in absolute value, of an electron, the dipolar electric moment is given by the product [e·δ] and can be measured in the unit [e·m] (electron·meter). In the literature it is, generally, measured in the unit [C·m] (Coulomb·meter) or in the unit [D] (Debye), being 1 D equivalent to 3.336·10⁻³⁰ C·m or 0.2082·10⁻¹⁰ e·m. For water it is 1.85 D, equivalent to 0.3852·10⁻¹⁰ e·m, resulting in δ=0.3852·10⁻¹⁰ m=0.3852 Å.

With reference to FIG. 1, a substance under treatment (liquid, in gas form or solid) is subjected, in a Treating Chamber 1, realized within a Treating Tube 14, to the action of an alternating magnetic field at waves generally sinusoidal (but that can be also rectangular or rectangular with rounded-off corners) with vector “magnetic induction” B perpendicular to the direction of the thrust to be obtained and, simultaneously, to an alternating electric field, isofrequential and with the same characteristics in regard to the form of the wave, with vector “electric field strength” E perpendicular to both B and to the direction of the thrust.

In the following treatment let's consider the case of the molecular polarization and neglected the change of the dipolar electric moment due to the effect of the vector E of the external electric field. However, it is pointed out that in all types of polarization the phenomenon of the production of the periodical thrust in a same oriented direction is identical to that of the molecular polarization.

In the present invention there are included all types of waves, sinusoidal, pulsatory or of intermediate form between the rectangular and the sinusoidal. These last ones can be generated, for example, by an inverter.

In the following, throughout the description of the invention:
sinusoidal waves are considered, unless otherwise indicated,
in a right-handed system at three orthogonal co-ordinate axes [x, y, z] there are indicated with “x” the direction of the thrust, with “z” that of the magnetic field (vector B) and with “y” that of the electric field (vector E).

With reference to FIG. 3, in which the sinusoid of the vector B is shifted in advance with respect to that of the vector E, when the vector E at the instant t1 (indicated on the axis of the abscissae) undergoes an inversion, it begins to move a molecule tending to lay parallelly to itself the axis connecting the centers-of-mass of the positive and negative charges of the same molecule, with the positive center-of-mass pointing towards the instantaneous negative pole of the electric field. This movement leaves unchanged the position of the center of the molecule. It will be called in the following “stretching”. In order that the stretching take place it is needed, however, that the electric field already have a certain intensity. Therefore, the stretching will take place and be completed in correspondence of an interval t2-t2′ of the sinusoid of the vector E at a certain distance from the inversion point t1. The length of this stretching interval will depend on the intensity of the electric field applied, on the chemical-physical properties of the substance under treatment and on the temperature.

With reference to the schematization made of an electron and a positron aligned in the y-direction and separated by the distance [δ], the stretching is a movement which has, both for the electron and the positron, a component in the y-direction. Since the electron and the positron during this movement are subjected to the action of the magnetic field B acting in z-direction, they will undergo a Lorentz force in x-direction. This force will act in a same way both for the electron and the positron, since they have of opposite sign not only the electric charge, but also the way of the vector velocity. In this way will act, consequently, a Lorentz force on all the molecule.

The molecule, after the stretching and up to the end of the half-period of the electric field (interval t2′-t3) remains still and does not undergo, therefore, any Lorentz force independently of variations of the magnetic field. When the electric field will again be inverted, at a certain distance from the inversion point t3, the molecule will undergo a new stretching (in the interval t4-t4′) in the opposite direction, but will be exposed to a magnetic field inverted with respect to the previous half-period. It will undergo, therefore, a Lorentz force equal in absolute value and directed, still along x, in the same way as that of the previous half-period. The way of the Lorentz force in the x-direction depends on the phase relation between the vectors E and B.

The average Lorentz force acting on all the molecule in a full period [T] of the oscillation can be calculated introducing into the formula

F_{L}=−e·B·v,

(written in scalar form and valid only for vectors E and B perpendicular to each other) the charge [e] of the only electron, and the average velocity [v] of the electron relatively to the positron. Being [2δ] the distance covered by the electron with respect to the positron in a half-period, and [4δ] in a full period, the average velocity [v], indicating with [f] the frequency, is calculated as

v=4δ/T=4δ·f

The average velocity [v] will be called, in the following, “velocity of the schematic equivalent electron”, or simply “equivalent velocity”.

The absorption of current corresponding to the theoretical compression power is nearly totally at charge of the electric field and takes place during the stretching of the molecules. In fact, the displacement of the schematic equivalent electron in y-direction causes on a whole molecule another displacement in x-direction, which is contrasted by the counter-pressure acting on the fluid under treatment flowing, for example, through a pump. In moving the molecule in x-direction the electron finds, therefore, a resistance, to overcome which it executes a work, absorbing current from the electric field.

A first critical factor for the working of the process is the “relaxation time” of molecules subjected to electric fields.

In the literature it is defined as “relaxation time” the time necessary for a molecule of a substance subjected to an electric field to return, after exclusion of such field, to its spontaneous orientation, which is determined, in the case of a liquid, by the mutual electromagnetic interactions (due to dipolar electric moments, dipolar magnetic moments, etc.) with the surrounding molecules. The intensity of such interactions decreases, still in the case of liquids, with increasing temperature, since the thermal agitation of the molecules tends to free them from one another. The effect of the above interactions can be considered as inexistent in the case of gases.

If the relaxation time gets near the half-period of the electric field applied, a resonance case takes place, in correspondence of which strong effects of agitation in the molecules and high dispersions of energy are determined.

The relaxation times in the molecular polarization are relatively long, because of which, for most polar molecules, such polarization can be, practically, utilized only up to a maximum of 100 MHz. In the electronic and atomic polarizations the relaxation times are much shorter, allowing the employment of higher frequencies.

A second critical factor is the phase relation between the magnetic and electric fields.

From FIG. 3, in which for easier explanation a very short stretching interval t2-t2′ is shown, it is evident that if, in this interval, the induction B is at the inversion point of its sinusoid, and then at its zero value, the Lorentz force is reduced to zero. If the value of B in the above interval is not near its positive or negative peak value the Lorentz force and the yield of the process considerably decrease.

A third critical factor is the length of the stretching interval.

This length is changed by regulating the voltage of the electric field.

The stretching interval:
must be of length shorter than the fourth of the wavelength and such as, in relation to the phase shift between the two vectors E and B, to allow the working of the process according to the scheme of FIG. 3,
must be sufficiently long to avoid that the absorption of current in the electric field for the compression work take place by too short impulses.

With reference to FIG. 3, in order that the process can work with optimal yields it is necessary to determine the phase relation between the vectors B, E (and then between the vectors I, E, being I the current sent to the magnetic field) and the intensity of the vector E in such a way that the stretching interval approximately cover at least a fourth of the wavelength and that in such interval the sinusoid of the vector B be at its maximum values, positive or negative. This can be obtained, for example, if B is in advance with respect to E by an angle comprised between 0° and 45°.

The electronic polarization is the only choice for the apolar molecules. It requires, however, very high voltages for the electric field, due to the scarce deformability of the atoms. Advantages of the electronic polarization are to be present for all species of monoatomic or multiatomic molecules and to have, as already said, “relaxation times” (in the order of 10⁻¹⁶ s) by far shorter than those of the molecular polarization, which allows the utilization of high frequencies.

The waves of the electric field can be replaced by Hertz waves obtained, for example, from a magnetron. They, in fact, cause stretchings of the molecules, due to the effect of their dipolar electric moment, identical to those produced by waves of electric voltage. It is necessary that the oscillations of the Hertz waves be in the direction of the vector E of the electric field, which they replace.

It is presented in the following a general scheme of calculation (Basis Project) for the realization of a propeller apparatus for fluid with rectilinear Treating Tube, in a particular process case and utilizing the molecular polarization. This scheme serves as track for the planning of all other applications (also for helicoidal Treating Tube, as generator, as separator of chemical-physical components and as rotatory electric motor), with all other types of polarizations, for any arrangement in an apparatus of the Treating Chambers, and for any choice of the values of the electric quantities (in particular, for range of choice of frequencies from 10 Hz to 100 GHz, and of the voltages from 10 V to 1 MV).

The type of application chosen is that of motor (pump for water), 4 m³/h, 4 Kg/cm² gauge, 1 MHz, turns with ferrite nuclei).

It is still considered the right-handed reference system at orthogonal co-ordinate axes [x, y, z] utilized for FIG. 1.

The complete apparatus comprises, in general, a certain number of propellers to be connected with one another in series and parallel combinations. In the case here considered one only propeller is employed.

A Frequency Converter 2 at two outlets 2a and 2b (First and Second HF—High Frequency—Line) connected at its inlet 2c to a Power Net at 50 Hz, supplies to all the apparatus:
from the First HF Line 2a, for the generation of the magnetic fields, an alternating current (I=13.8 A), 1 MHz, at sinusoidal waves,
from the Second HF Line 2b, for the generation of the electric fields, an alternating voltage, isofrequential with the current of the First HF Line 2a and with the same characteristics as regards the form of the wave.

The alternating voltage of the First HF Line 2a must be such as to make circulate in the circuit of the propellers the intensity provided for the current.

The alternating voltage of the Second HF Line 2b must be such as to secure within the Treating Chamber 1 for the electric field strength E a number of V/cm sufficient to produce an efficient stretching of the molecules.

In the First HF Line, downstream the Frequency Converter, there is placed a Variable Non-Inductive Resistance 3. After this the current is sent to the Propeller 4. In the Second HF Line downstream the Frequency Converter there is placed a Voltage Transformer 9, which raises and regulates the voltage for the electric fields, and, next, a Phase Regulator 10, which allows to regulate the phase relation between the electric field strength E of the electric field and the vector B of the magnetic field in the inside of the Treating Chambers.

The Propeller 4 consists of the following elements.
A Treating Tube 14, internally empty, lying along x, in which the water flows, from an inlet 11 and an outlet 12. In the Treating Tube, having preferably the outside sizes along yz of 18×12 mm and long in x 346 mm, there are realized Treating Chambers 1 (preferably four), having preferably length along x of 24 mm each, spaced between each other preferably 50 mm.
A Winding formed by a multiplicity of turns 7, preferably eighth, placed one above (along z) and one beneath each Treating Chamber. In such turns, in series connected, the electric current for the generation of the magnetic field circulates. The axis of each turn lies along z.
A multiplicity of ferrite plates 8, preferably eight, forming the magnetic nucleus of each turn. Each plate has preferably the sizes along yzx 18×8×24 mm. It is preferably employed ferrite at high value of relative permeability μ=10000.
A multiplicity of Resonance Condensers 6, preferably eighth, interposed each at the connection between two subsequent turns 7 of the winding. Function of each of these condensers is that of supplying a reactive voltage equal and of opposite sign (of capacity) with respect to the inductive voltage which is determined in the preceding turn, thus avoiding to make the same inductive voltage reach excessive values for all the inductor.
A multiplicity of Process Condensers 5, preferably four, each formed by two parallel plates (armature) laid in such a way to produce an electric field directed along y through each Treating Chamber 1. The two plates of each Process Condenser are preferably long in x 24 mm and are placed, generally outside the Treating Tube, at the minimum possible distance from the walls of this, securing anyway the insulation from the ferrite. In general it is possible also, for certain fluids, to place the two plates inside the Treating Tube, at direct contact with the fluid, and also to restrict the length along y of the Treating Chambers with respect to that of the ferrite plates and of the Treating Tube outside the same Treating Chambers. The Process Condensers are connected among one another in parallel, and their complex is inserted downstream the Phase Regulator 10. The voltage to be applied to the plates is that directly supplied by the Frequency Converter 2 in the Second HF Line 2b.

The sizing has been chosen trying to obtain that the flux lines of the vector B do not run out, as far as possible, of the “nucleus” of the magnetic field.

It is not strictly necessary, instead, that the same flux lines exactly run parallelly to the axis of the winding, nor that their distribution in the section of the nucleus of the magnetic field be uniform. In fact, the total thrust received by the fluid in a Treating Chamber depends only on the total number of flux lines of the vector B “cut” by the same fluid flowing through the Chamber.

The arrangement here considered of the Treating Chambers will be called “arrangement at aligned Treating Chambers”.

It is possible to take into consideration, as realization variant, also an “arrangement at superimposed Treating Chambers”, in which between two subsequent Chambers it is present one only ferrite plate at immediate contact with the same Chambers.

This second arrangement appears altogether as less favourable, above all for the necessity of connecting the outlet from a Chamber with the inlet into the subsequent one by means of return tubes external to the winding, with consequent constructive complications and increases in pressure losses for the flow of the fluid.

The number of molecules per cm³ is obtained as follows:

molecular mass H₂O in units “u” 18.0153
unit “u” 1.66054·10⁻²⁷ Kg
mass of the molecule H₂O 18.0153·1.66054·10⁻²⁷=2.99151·10⁻²⁶ Kg
massa of 1 cm³ H₂O 10⁻³ Kg
number of molecules H₂O per cm³ 10⁻³/2.99151·10⁻²⁶=3.3428·10²²

The “equivalent velocity” of the schematic “equivalent electron” is obtained as follows:

equivalent arm of dipolar electric moment δ=0.3852 Å=0.3852·10⁻¹⁰ m
frequency f=1 MHz=10⁶ s⁻¹
equivalent velocity v=4·δ·f=4·0.3852·10⁻¹⁰·10⁶=1.541·10⁴ m/s

The data relating to the propeller are the following:
current for the magnetic field I=13.8 A
frequency f=10⁶ s⁻¹ (wavelength λ=300 m)
angular velocity ω=2π·f=6.2832·10⁶ s⁻¹
height along z of the propeller 28 mm
ferrite plates thickness 8 mm, μ=10000, area 4.32 cm².

To allow, according to a simplified calculation, of the ferrite, it is introduced into the following formulas for each Treating Chamber an average value

μ=10000·16/28=5714.

For the calculation of the inductance in the turns it is neglected, in first approximation, the difference between the internal area of a turn and that of a ferrite plate (4.32 cm²).

For 1 turn

### Inductance L=1.2566·10⁻⁶·5714·1²·4.32·10⁻⁴/0.014=221.56·10⁻⁶ H

### Reactance X_{L}=ω·L=6.2832·10⁶·221.56·10⁻⁶=1392.1 Ω

Inductive voltage V_{L}=X_{L}·I=1392.1·13.8=19211 V
For 2 turns

### Induction

B=1.2566·10⁻⁶·5714·2·13.8/0.028=7.078 T (Tesla, V·s/m²)

Force on 1 molecule (e=1.60219·10⁻¹⁹ electric charge of the electron in Coulomb)

F_{H2O}=e·B·v=1.60219·10⁻¹⁹·7.078·1.541·10⁻⁴=1.7475·10⁻²² N/molecule
Theoretical thrust on 1 cm³ of the tube (unitary volumetric thrust)

### F_{H20}·3.3428 10²²·1=1.7475·10⁻²²·3.3428·10²²·1=5.842 N/cm³

Pressure head (total length along x of the Treating Chambers 9.6 cm)

5.842·9.6=56.08 N/cm².

The same value of the pressure head is arrived at according to an equivalent calculation scheme, as described in the following.

The total charge of equivalent electrons contained in a cm³ of water is

1.60219·10⁻¹⁹·3.3428·10²²=5355.8 C.

Multiplying this charge by the “equivalent velocity” expressed in cm/s a “fluid-internal equivalent current” expressed in A/cm² is obtained

5355.8·0.01541=82.533 A/cm²

Multiplying this last one by the section zx of a Treating Chamber (12×24 mm, 2.88 cm²) it is obtained the internal equivalent current on the full section of a Chamber (82.533·2.88)=237.7 A (it is, then, as if in place of the water in each Chamber there were a small cylinder of copper 1.8 cm long in y-direction, in which a current 237.7 A would flow).

To have the thrust in N/cm² the current 82.533 A/cm² is multiplied by the total length along x of the 4 Chambers (9.6 cm), by the induction B in Tesla and by the length 1 cm in y-direction (0.01 m)

82.533·9.6·7.078·0.01=56.08 N/cm².

This thrust (pressure head) is to be reduced through a safety coefficient, for example 0.7, to allow for various factors, among which the simplifications made in the electromagnetic calculation, the discrepancy from the optimal phase relation between the magnetic and electric fields in the Treating Chambers, the partial running-out of the Treating Chambers by the flux lines of the magnetic field and the pressure losses of the fluid along the tube.

It is obtained a thrust of (56.08·0.7)=39.26 N/cm², equivalent to 4.002 Kg/cm². It is, then, sufficient one only propeller.

The approximate sizes of the complete apparatus can be 150×150×500 mm.

With a thickness of the tube 1 mm the internal section is 1.60 cm² and the velocity of the fluid at 4 m³/h is 6.94 m/s.

In each turn of a propeller 4 the inductance has been calculated at 221.56·10⁻⁶ H. Te capacity of each Resonance Condenser 6 results

C=1/(ω²·L)=1/[(3.1416·10⁶)²·221.56·10⁻⁶]=114.3·10⁻¹² F.

The Resonance Condenser must be planned to withstand a perforation voltage 25000V.

The complex of the Process Condensers 5 is fed, as already said, by a voltage directly supplied by the Frequency Converter 2 in the Second HF Line 2b through Voltage Transformer 9 and Phase Regulator 10.

Still according to what already said, the voltage in the Process Condenser 5 is to be set, practically, experimentally, but this does not involve difficulties for the technician of the specific branch. With the voltage chosen, then, it is calculated the current absorbed, on the basis of the theoretical compression power (435 W) and of the yield foreseen for the propeller.

From the previous formulas it is seen that, at unchanged geometric sizing, both the inductive voltage in the turns and the total thrust on the fluid do not vary if the product [μ·l·f] of the relative permeability, the current and the frequency remains constant.

The inductive voltage in a turn (19211 V) is very high. In order to, for example, halve it many solutions are possible, among which the following.
Doubling the number of the Treating Chambers, keeping unchanged the frequency and halving the current (to 6.9 A).
Still doubling the number of the Treating Chambers, keeping unchanged the current and halving the frequency (to 500 KHz).

If it is chosen to double the number of the Treating Chambers, instead of placing eighth of them aligned along the Treating Tube, it is possible to provide two propellers equal to that of this Project, connecting them aside of each other along y, suitably spaced. In both propellers the oriented direction of the electric field (vector E) is kept unchanged, while in the second the direction of the vector B of the magnetic field is inverted (exchanging the connections to the terminals of the current to the winding). The way of the flow of the fluid in the second propeller results inverted with respect to that of the first one.

The flux lines of the magnetic field in outlet from a Treating Chamber of the first propeller re-enter partially the Treating Chamber at its side of the second propeller in opposite direction. In this way the total magnetic field of two Treating Chambers at the side of each other closes itself in space “at ring”, with consequent better utilization of the magnetic flux lines in the complex of the two Chambers. This type of connection between two propellers will be called, from now on, “arrangement at Treating Chambers aligned and Treating Tubes side by side”.

The scheme of propeller now presented must be intended as indicative.

The possibilities of variation are several, and some of them are described in the following.

A first possibility of variation to the Basis Project is that of realizing the winding with turns “in air” (without magnetic nucleus in their inside).

With this choice, if the frequency is not raised (to avoid the various consequent problems), it is necessary to considerably increase the number of the Treating Chambers, which leads to rather encumbering structures with many propellers.

Not being possible to exceed certain limits in the intensity of the currents, the inductive voltages in the windings do not result particularly high, because of which, instead of placing in a propeller a Resonance Condenser at each turn, there is the possibility of providing one at any multiple of turns, or one only at the end of the winding.

A second possibility of variation to the Basis Project is that of operating with one only HF Line.

In the process flow scheme of FIG. 1 the Second HF Line 2b is eliminated and the voltage to be sent to the Process Condensers 5 for the electric field is taken directly from the First HF Line 2a downstream the Resistance 3, or between two points, suitably chosen, of the circuit of the winding of the propeller (composed of the turns 7 and the Resonance Condensers 6).

This Project would have the advantage of eliminating the Second HF Line, with related elements 9 and 10, but would present problems to secure the working of the process according to what previously described and to the scheme of FIG. 3.

Even if the process can work, though with low yields, with vectors B, E in phase, it is rather difficult to find acceptable effective values for the two above vectors B, E. A realization of this kind is, consequently, possible only in a very limited number of cases, in which, among other, considerations on the energetic yield be not determinant, as in certain separations of components.

A third possibility of variation to the Basis Project is that of arranging the Treating Chamber directly in the inside of the turns generating the magnetic field, in a type of propeller (“helicotron”) at helicoidal Treating Tube (not shown in the figures).

The Treating Tube at circular section, of the outside diameter, for example, 25 mm, is wound at helicoid, forming a coil of the outside diameter 16 cm. Outside and inside the coil, at the minimum distance from it, two windings of turns, respectively “primary winding” and “secondary winding”, are placed.

To the primary winding the current for the generation of the magnetic field is sent. The secondary winding is left open at both ends. The magnetic field produced by the primary winding induces between two points of the two windings in front of each other an alternating voltage shifted in phase, with respect to that sent to the primary winding, according to the Lenz rule. The conductors of the two windings exert the function of the two plates of the armature of a Process Condenser 5 of FIG. 1. The Lorentz force on the fluid in the coil results directed tangentially to the same coil. One only Resonance Condenser (6 of FIG. 1) is to be provided downstream the primary winding.

In alternative, the secondary winding can be fed, as in FIG. 1, by a Second HF Line in outlet from the Frequency Converter 2. In such case, upstream and downstream the secondary winding, respectively, another Non-Inductive Variable Resistance 3 and another Resonance Condenser 6 are to be placed.

A propeller at helicoidal Treating Tube would allow to optimally utilize the magnetic field, the electric one and the Treating Tube itself, in that it would have all the advantages deriving from a physical process continuous and uniform along the full path of the substance under treatment. However, the realizability of such a propeller is rather problematic and possible only in simple cases.

A fourth possibility of variation to the Basis Project is that of utilizing Hertz waves in place of the electric ones.

As already previously said in relation to the principle of operation of the process, the waves of the electric field can be replaced by Hertz waves obtained, for example, from a magnetron. These waves must produce oscillations in the direction of the vector E of the electric field that they replace.

This is realizable by placing, with reference to FIG. 1, in correspondence of a plate of the armature of each Process Condenser 5, a “launcher” of the type of that employed in the microwave ovens, orienting it in such a way to launch the waves, eventually guided by a proper “wave guide”, towards the opposite plate (in y-direction).

For the Basis Project and the related four variations the following considerations apply.
1) The phase relation between the two magnetic and electric fields in the Treating Chambers is influenced by the length of the conductors of the turns. If this length is considerable with respect to the wavelength, in order to have in the Treating Chambers a phase relation between the two fields such as to make possible the working of the process it is necessary to subdivide the Process Condensers 5 into a certain number of groups. In such case, in each group such condensers are to be put in parallel, and each group is to be connected downstream the Voltage Transformer 9 through a separate Phase Regulator 10. The Phase Regulator can, in certain cases, be absent. This is possible in the case of high frequencies, for example about 1 GHz (always possible with this technology utilizing the electronic polarization), since at such frequencies, to which a wavelength of few tens of centimeters corresponds, to regulate, in each Treating Chamber, the phase of the vector E it is sufficient to vary the length of the cables that bring the current to the Process Condensers.
2) The maximum practically acceptable value of the inductive voltage in the winding can be one of the main limiting factors in the thrust obtainable from a propeller. To limit the disadvantage of high inductive voltages, in the Basis Project a Resonance Condenser has been inserted at any turn. If the inductive voltages are low, it is possible to put a Resonance Condenser at any multiple of turns, or to provide one only at the end of the inductor. An advanced application is that of realizing a turn with a “compound” conductor, formed by several stretches, inserting at the end of each stretch a Resonance Condenser calculated to eliminate the inductive voltage produced in the same stretch. It results, so, a “bead string” conductor, with the “beads” more or less close to each other. With such a compound conductor it is possible to realize, at equal vector B, inductors with relatively great internal sections containing the inductive voltage within limits practically acceptable.
3) It is possible and convenient in certain cases to keep the sinusoidal form for the waves of the electric field and to send to the turns of the inductors alternating isofrequential impulses, determining their angular position with respect to the sinusoid of the electric field and their duration in such a way that the Treating Chambers be crossed by the vector magnetic induction B only for the time strictly necessary to produce the Lorentz forces required (pulsatory waves). In other words, the impulses to the inductors should act, in each half-period, only for the minimum time interval comprising the stretching interval of the molecules. These impulses can be easily generated by a microprocessor, that can also be incorporated in an inverter provided for the sinusoidal waves of the electric field. There is the advantage of sending to the inductors, at equal heating of the conductors and the eventual magnetic nuclei, much more intense currents. All this can be convenient mainly in stationary high-power plants operating at low frequencies.

The present invention finds a first application as pump for liquids.

The advantages presented by this technology with respect to the traditional groups [electric motor/centrifugal pump] result considerable, for the following facts:
employment of mechanically static elements only, with elimination of vibrations, noise and all other problems related to the presence of mobile parts,
great savings in construction, considering that the apparatus results compact and that the centrifuge wheel part is eliminated,
higher yields, in that those of the centrifugal pumps are low and rapidly decrease at the reduced throughputs,
considerable savings in the maintenance costs, due to the absence of sliding or rolling contacts and seal surfaces,
great savings in construction in the case of highly corrosive or dangerous liquids (as, for example, those utilized in the nuclear power stations).

The disadvantages are represented mainly by the necessity of employment of high frequencies, with related Frequency Converters (inverters or magnetrons) and, in certain cases, by greater encumbrances. Moreover, the planning of a pump is to be made in relation to the chemical-physical properties of the substance under treatment.

The convenience to utilize a pump at dipolar electric moment can, therefore, exist in certain cases and in other not.

The considerations made on this technology at dipolar electric moment for the pumps for liquids are valid, in general, also for the compressors for gases.

The compression of gases utilizing the dipolar electric moment is, however, less favourable than the pumping of liquids, due to the lower densities of gases and the consequent necessity of greater flowing sections in the Treating Chambers.

In accordance with the present invention it is possible, moreover, to build propellers for solid substances in pieces, powder, or suspension in liquids, as, for example, wheat in corns, milk in powder, coal powder suspended in water, etc.

In conformity with the present invention a rotatory electric motor can be realized according to one of the schemes previously described, and exactly according to that of the helicotron (third variation to the Basis Project), placing the primary and secondary windings respectively in the stator and the rotor. The coil is replaced with small long cylinders placed at the periphery of the rotor (immediately outside the secondary winding) parallelly to the axis of the motor. Each of these small cylinders is closed at the ends and filled with a polar substance (at intrinsic or ionic polarization), liquid or preferably solid.

The motor has no electric connections between stator and rotor.

The present invention has application also as generator of electricity fed by liquids, for which, in general, the same considerations made for the pumping of liquids are valid.

For the replacement of the groups [turbine-alternator] of the hydroelectric power stations it can be studied also the planning of generators directly for the frequency 50 Hz. For such an application it is to be considered that the very low frequency and the very high inductive voltage acceptable allow a very strong current intensity. For this reason it can be convenient, dealing with high-power, stationary plants, to utilize superconductors kept at the temperature of the liquid helium, to eventually employ pulsatory waves for the magnetic field, or to insert more Resonance Condensers in each turn.

The present invention has application also as generator of electricity fed by gases (for which the same considerations made for the compression of gases are valid).

The present invention has application also as flow indicator for fluids.

An apparatus for the flow measurement of fluids with the technology at dipolar electric moment is constructed as a generator of electricity.

With respect to the traditional measuring methods such an indicator has the advantage not to introduce sensible pressure losses into the pipes and to directly measure the mass of the fluid. It requires a Frequency Converter (called also “Feeder” in the present description), that can be, anyway, shared among several indicators and, eventually, with pumps or compressors.

The present invention finds utilization also as separator of components from a mixture.

The separation of chemical or physical (isotopes of atoms) components with the technology at dipolar electric moment presents some very complex problems, that differentiate it from the other applications of the same technology.

In the utilization as motor or generator (even if the substance under treatment is a mixture of two or more components) it deals with a process of total propulsion, in which the thrust on the molecules is totally utilized, while in the separation of two components the process is of differential propulsion, in that it is utilizable only the differential thrust separately calculable on the molecules of the same two components.

The separations of mixable liquids and gases spontaneously occur also in nature in the field of gravity, when the specific gravities of two components differ. Example x can be for the mixable liquids the stratification of heavy water in the ocean depths (in which the percentage of D₂O is higher even by 30% than that existing at the surface), and for gases the stratification of carbon dioxide in the grounds adjacent to the perforations of the geothermal plants.

For a first estimate of the intensity and velocity of separation of two components subjected to different volumetric thrusts it is possible to utilize criteria based on the comparisons with experimental observations of similar phenomena spontaneously occurring in nature, as the two above mentioned, or realizable in the laboratories.

To this purpose the following definitions are introduced.
Unitary volumetric thrust on a pure component is the total thrust from dipolar electric moment on all the molecules of the component existing in the unit volume. Measurement unit is the N/m³.
Unitary differential volumetric thrust between two components is the difference between the unitary volumetric thrusts separately calculated for the two pure components. Measurement unit still the N/m³.

For an effective and industrially utilizable separation of two components, with a determined purity of each of them, the following 2 factors are to be considered:

F1—value of the unitary differential volumetric thrust between the two components (N/m³).
F2—exposure time of the mixture to the action of the thrust (s).

One determines, for each mixture, a pair of values of the above 2 factors such as to produce a satisfactory separation and, on its basis, goes on, then, to the planning of an industrial application.

In the mixable liquids there are electromagnetic interactions, as already said, among the molecules (from dipolar electric moments, from hydrogen bonds in certain substances, etc.) that are present also in the absence of external electromagnetic fields. These interactions have no influence on the thrusts in the total propulsion. In the differential propulsion, instead, the differential thrust exerted on two heterolog molecules is, generally, reduced due to the effect of the above interactions. The intensity of the same interactions decreases with increasing temperature, since the thermal agitation tends, as already said, to free the molecules from one another.

Altogether, the reduction of differential thrust can be, in certain mixtures, considerable, so to make difficult or quite impossible the separation of the components.

In gases the electromagnetic interactions among the molecules can be considered as absent. In the differential propulsion the differential thrust exerted on two heterolog molecules is, generally, also for gases, reduced. This, however, for the collisions among the molecules, which tend to reduce the differences of velocity among the same molecules.

The separation of components with physical methods is made presently in the industry on the mixture of the liquid components, liquifying them is originally available in gas phase, mainly with fractional destillation, according to what already previously described.

The separation of liquid components with technology at dipolar electric moment is made in the following way.

The liquid mixture of the two or more components is introduced at an intermediate point of a Treating Tube, internally empty, in the inside of which a set of Treating Chambers, suitably spaced, is realized. The molecules of the components are subjected to axial thrusts proportional not to their masses, as happens, for example, in the centrifuges or in the field of gravity, but to their dipolar electric moments. The two components, or groups of components, to be separated, under the action of a differential force, migrate each towards an end of the tube, from which they are extracted.

In the comparison with the traditional method, the equivalent of a destillation tray is a stretch of the Treating Tube into which the mixture of the components to be separated is introduced. The inside of the tube is empty, and this involves enormous simplification and reduction of construction costs with respect to the system at destillation columns.

The savings in the costs of construction and operation are, in the new system, particularly great in the case of gas start mixtures (as nitrogen and oxygen from air, in that it is avoided the process, very expensive, of their liquefaction and eventually their subsequent gasification).

Also for liquid start mixtures the savings in the operation costs are, in the new system with respect to that of the destillation, very high, above all for the fact that it is avoided the vaporization of liquids in quantities that can be a multiple even high of that of the liquid of the feed, as in the case, already mentioned, of the propane-propylene separation.

In addition to the savings in construction, operation and maintenance it can be considered also the advantage of having structures more compact and arranged horizontally, instead of vertically. In fact, in a destillation column the trays are piled vertically and, when the column results very high (for example, over 60 meters), it is subdivided into two or more parts connected in series.

The separation of liquids appears as very promising, for example, in the following cases:
of propane-propylene mixture,
of water-ethyl alcohol mixtures for the direct production of anhydrous alcohol (also for fuel),
of water-ethyl alcohol mixtures for the concentration of alcoholic drinks, in which there would be the advantage, with respect to the destillation, represented by the fact that all aromatic substances present in the charges would pass into the alcoholic phase and without being damaged in any way for heating.

The separation of gas components with technology at dipolar electric moment is made, directly in gas phase, in a Treating Tube as in the case of a liquid mixture.

It is considered, as first example, the nitrogen-oxygen separation from air in gas phase with utilization of the electronic polarization at the frequency of 1 MHz.

The apparatus is described in FIG. 2. The process scheme is identical, apart from the choice of the electric quantities and the sizing, to that of the Basis Project (pump for water), with the only difference that the inlet of the fluid (air) is made at an intermediate point 13 of the Treating Tube, from the ends of which 11 and 12, respectively, the oxygen and the nitrogen come out.

The Treating Tube 14 has the internal section preferably of 60×30 mm. A Treating Chamber 1 is realized as stretch 60 mm long of the tube.

45 Treating Chambers are placed within the tube, aligned in x-direction (arrangement at aligned Treating Chambers) and spaced from each other 60 mm. The physical length of the Treating Tube is 5.4 m, and that total useful in correspondence of the Treating Chambers 2.7 m.

Above and beneath each Chamber it is placed a plane turn 7 with, at its inside, a ferrite plate 8 (μ=10000), 20 mm thick. In the two turns, connected in series, of the Chamber the current for the generation of the magnetic field circulates.

At the end of each turn a Resonance Condenser 6 is placed in series.

The Process Condensers 5 are as in the Basis Project. The current is 50 A.

The polarizability constants [α′=α/(4πε₀)] have been taken from the literature.

The electric influence constant ε₀ has the value, in SI (Standard International) units 8.8542·10⁻¹².

| | N₂ | O₂ |
|---|---|---|
| α′ = α/(4πε₀) m³ | 1.770 · 10⁻³⁰ | 0.793 · 10⁻³⁰ |
| dipolare moment e · m/(V/m) | 1.229 · 10⁻²¹ | 0.551 · 10⁻²¹ |

To allow, according to a simplified calculation, for the ferrite plates it is introduced into the following formulas for a total Treating Chamber (with 2 turns) an average value of the relative permeability μ=10000·2·2/7=5714.

For the calculation of the inductance in the turns it is neglected, in first approximation, the difference between the internal area of a turn and that of a ferrite plate (36 cm²).

For 1 turn

### Inductance L=1.2566·10⁻⁶·5714.1²·36·10⁻⁴/0.035=738.5·10⁻⁶ H

### Reactance X_{L}=ω·L=6.2832·10⁶·738.5·10⁻⁶=4640.1 Ω

Inductive voltage V_{L}=X_{L}·I=4640.1·50=232005 V
For 2 turns
Inductive voltage 1.2566·10⁻⁶·5714·2·50/0.07=10.257 T

There result a very high inductive voltage in each turn (232005 V) and an induction in each Treating Chamber 10.257 T.

Each Resonance Condenser 6 has the capacity

C=1/(ω²·L)=1/[(6.2832·10⁶)²·738.5·10⁻⁶]=34.30·10⁻¹² F.

Applying an electric field 20000 V/cm (2·10⁶ V/m) the equivalent arms of dipolar electric moment δ result

δ_{N2}=1.229·10⁻²¹·2·10⁶=2.458·10⁻¹⁵ m

δ_{O2}=0.551·10⁻²¹·2·10⁶=1.102·10⁻¹⁵ m

The equivalent electron velocities v are calculated as

v_{N2}=4·δ_{N2}·f=4·2.458·10⁻¹⁵·10⁶=9.832·10⁻⁹ m/s

v_{O2}=4·δ_{O2}·f=4·1.102·10⁻¹⁵·10⁶=4.408·10⁻⁹ m/s

The thrusts on the two molecules result

F_{N2}=e·B·v_{N2}=1.60219·10⁻¹⁹·10.257·9.832·10⁻⁹=1.6158·10⁻²⁶ N/molecule

F_{O2}=e·B·v_{N2}=1.60219·10⁻¹⁹·10.257·4.408·10⁻⁹=0.7244·10⁻²⁶ N/molecule

The differential thrust is

(1.6158·10⁻²⁶-0.7244·10⁻²⁶)=0.8914·10⁻²⁶ N/molecule.

This differential thrust is multiplied by a safety coefficient 0.7, in analogy with what made for the Basis Project. It is obtained a differential thrust

0.8914·10⁻²⁶·0.7=0.6240·10⁻²⁶ N/molecule.

The number of molecules per unit volume, equal for the two components, in normal conditions (0° C. and 760 mm Hg) is calculated on the basis of the Avogadro constants(6.02252·10²³ molecules/g-molecule and 0.022414 m³/g-mol).

6.02252·10²³/0.022414=2.6869·10²⁵ molecules/Nm³.

Operating at 50 Kg/cm² gauge and 50° C. there are

2.6869·10²⁵·[(50+1.033)/1.033]·(273/323)=1.1219·10²⁷ molecules/m³.

The unitary differential volumetric thrust at 50 Kg/cm² gauge and 50° C. results

0.6240·10⁻²⁶·1.1219·10²⁷=7.001 N/m³.

It is, then, F1=7.001 N/m³.

For comparison, in the case of the stratification of carbon dioxide in the grounds in the vicinity of the perforations of the geothermal plants the unitary differential volumetric thrust calculated on 1 m height from grade is about 6 N/m³. Such thrust is sufficient to determine a high CO₂ concentration in the first 20 cm from grade even at the conditions of normal agitation of the atmosphere.

It can be thought that, for the value of F1 above calculated and for the separation grade required, there result a factor F2=10 s.

With internal section of the tube 14.56 cm² the volume of gas contained in correspondence of the physical tube length (5.4 m) is 7862 cm³.

The total flow in outlet from both ends is calculated considering that the volume of gas above determined must remain in the tube for (10·5.4/2.7)=20 s, being the physical tube length double than that useful. Such total flow results (7862/20)=393.1 cm³/s.

With O₂ concentration 21% the outlet O₂ flow is (393.1·0.21)=82.55 cm³/s, with outlet velocity from the related tube end (82.55/14.56)=5.67 cm/s and a production of 0.2972 m³/h, 12.410 Nm³/h (297.84 Nm³/day).

In one only apparatus, of the form of a long horizontal cabinet, there can be arranged several tubes, for example 100, in parallel for the flux of the air.

Such tubes can, for a better utilization of the lines of the magnetic fields, be connected by two's according to the connection at Treating Chambers aligned and Treating Tubes side by side already previously described.

With 100 tubes the production above calculated rises to 1241.0 Nm³/h (29784 Nm³/day).

Greater production would be possible, still at the pressure of 50 Kg/cm² gauge, by raising the intensity of the electric field, considering that the dielectric strength of air increases with pressure (at atmospheric pressure it is 25000 V/cm). Greater production would be possible also by raising the pressure, for example, to 200 Kg/cm² gauge.

At the pressure 3 Kg/cm² gauge, which can be required for many technical applications, the O₂ production, still operating with voltage of the electric field 20000 V, from 29784 Nm³/day would decrease to 2353.7 Nm³/day.

All this would be achieved with a certain consumption of electricity, due only to losses in the circuits (being the chemical-physical work for the separation negligible), but with great savings in energy, construction and maintenance with respect to the system by destillation.

A possibility can be seen also in the separation of the gases H₂ and CO, produced in mixture in numerous processes of the chemical industry. The separation would be easy utilizing the molecular polarization, since the CO molecule has an intrinsic dipolar electric moment, while the other H₂ molecule has not.

This would allow, among other, to utilize voltages in the electric field much lower, not being necessary to produce in the mixture to treat an electronic polarization.

Another application is the separation of electrolytes from liquids, as is the case, for example, of the desalting of sea water.

The interfacial (or ionic) polarization is utilized.

Introducing into a Treating Tube, at an intermediate point, sea water, there are obtained from an end of the tube a concentrated salt solution, and from the other desalted water.

This type of separation would have the advantage of arms of dipolar electric moment much greater than those considered in the non-ionic polarizations. In fact, the migrations of the ions due to an inversion of the electric field are of an order of magnitude higher than that of the displacements considered for the schematic equivalent electron in the other types of polarization.

The propeller finds application also for the purification of chemical substances for the purpose of eliminating, up to high grade, impurities from chemical substances for which it is needed to reach an extreme purity, as reagents for chemical analyses and intermediate products for crystals of silicon or gallium arsenide (for computers or photovoltaic applications).

Another industrial application can be that of the separation of the isotopes of atoms, in particular the separation of the isotopes of hydrogen and uranium

The separation of the isotopes of hydrogen would be made on hydrogen in the combined state, as water (mixture of H₂O, D₂O e T₂O) in liquid phase.

For a H₂O-D₂O separation a very long Treating Tube is needed, but the construction costs are much lower than those of the corresponding traditional plants (by destillation or electrolysis), and minimum are the energetic consumptions.

The separation of the isotopes of uranium can be executed on uranium in form of hexafluoride in liquid or gas phase. There are valid, for the separation of the isotopes U₂₃₅ e U₂₃₈, the same considerations made for the case of the isotopes of hydrogen.

As conclusive considerations, the thrusts on the substance under treatment are produced by exerting on its molecules a Lorentz force, intermittent and always directed in a same way, obtained by subjecting the same molecules to a combination of a magnetic field and one electric, alternating and isofrequential. The velocity necessary for the production of the Lorentz force is obtained by displacing, at each inversion of the electric field, the positive and negative electric charges of the molecules utilizing their dipolar electric moment pre-existing or induced by the external electric field. In alternative, the combination magnetic field/electric field can be replaced by another magnetic field/Hertz waves, realized in such a way to still utilize the dipolar electric moment of the molecules.

In the treatment of a mixture of chemical-physical components the thrusts on the molecules result different for the different physical properties of the same molecules, which allows to separate the components.

In the electric motors, at direct or alternating current, it is utilized the Lorentz force applied to the motion of (conduction) electrons travelling among atoms of a conductor. In this case an inter-atomic motion of electrons allows the production of a Lorentz force.

The motion of all the negative (electrons) and positive (nuclei) electric charges produced in the inside of an atom by the application of an electric (or at Hertz waves) field can be seen as an intra-atomic motion of equivalent electrons. This second motion of electric charges can be utilized, for the generation of a Lorentz force, exactly as the first, if the technology here described is adopted.

The spirit of the present invention is that of extending the application of the Lorentz force from the inter-atomic motion of electrons to that intra-atomic, amplifying and considerably improving, in the realization of motors/generators, that revolution of the mechanical industry that occurred in the second half of the nineteenth century, following the discovery by Lorentz, with the appearance of the electric motors and opening for the chemical industry, in regard to the separation of chemical-physical components, a field completely new and extremely profitable in the replacement of the fractionation processes presently employed.̂

It is described, now, another realization variant of the Basis Project.

The variant in question still regards the same application of the Basis Project, and therefore a pump for water with the throughput 4 m³/h and the pressure head 4 Kg/cm², and still utilizing the molecular polarization, but with different choice of the electric variables and different arrangement of the Treating Chambers.

As regards the electric variables the same variant considers a frequency 20 MHz and turns “in air” for the generation of the magnetic fields. Moreover, for the two magnetic and electric fields theoretically rectangular waves are considered.

It is necessary to point out that such rectangular waves represent a purely theoretical schematization adopted both to make easy the explanation of the operation of the physical process, and for the fact that rectangular waves would allow to realize, at equality of other conditions, more intense Lorentz forces. Waves of form near that rectangular can be practically produced only at relatively low frequencies. On the other hand, at the frequency 20 MHz perfectly rectangular waves could not be produced due to the intensity of the “transients” which would result in correspondence of the vertices of the rectangles.

The correspondent real waves are to be intended as of intermediate form between the rectangular and the sinusoidal (practically “flattened” sinusoids, as can be generated by an inverter).

For the employment of the above theoretically rectangular waves in the explanation of the operation of the process it is necessary to replace the scheme of FIG. 3 with that of the other FIG. 4, which is referred to in the following explanations.

There will be indicated, in a right-handed system at three co-ordinate axes [x, y, z], with “x” the direction of the thrust, with “z” that of the magnetic field (vector B) and with “y” that of the electric field (vector E). This reference system is identical to that of the Basis Project and is shown in FIG. 5.

With reference to FIG. 4, in which the vector B is shifted in advance with respect to E, when the vector E at the instant t2 (indicated on the axis of the abscissae) undergoes an inversion, it, if sufficient intense, moves a molecule tending to lay parallelly to itself the axis connecting the centers-of-mass of the positive and negative electric charges of the same molecule, with the positive center-of-mass pointing towards the negative instantaneous pole of the electric field. This movement impressed to the molecule will be called in the following “stretching”. The time required for this stretching, indicated in the figure as interval t2-t2′, depends, in the case here considered of the molecular polarization, on the chemical-physical characteristics of the substance under treatment and on the temperature. This time of stretching must be very short with respect to the fourth of period (stretch t2-t3) of the electric field.

With reference to the schematization made of an electron and a positron aligned in the y-direction and separated by the distance δ, the stretching, as regards the electron, is a movement which has a component 2δ in the y-direction with respect to the positron. Since this schematic electron executes, with respect to the antagonist positron, in y-direction and at a certain velocity, such a displacement 2δ, it is subjected, in the magnetic field B acting in z-direction, to a Lorentz force in x-direction, in a determined running way.

The molecule after the stretching and up to the end of the half-period of the electric field (stretch t2′-t4) does not vary its alignment and its orientation in the y-direction and does not undergo, therefore, any further Lorentz force independently of variations of the magnetic field. When the electric field will again be inverted, at the instant t4, the molecule will undergo a new stretching in the opposite direction, but will be exposed to a magnetic field inverted with respect to the preceding half-period. It will undergo, therefore, a Lorentz force equal in absolute value and directed, still along x, in the same way as that of the preceding half-period.

The average thrust on the molecule can be calculated as the force acting on an electron that cover, in uniform motion, in a second a distance equal to 4·δ·f, being “f” the frequency in Hertz, at an “equivalent velocity” 4·δ·f m/s.

The complete apparatus comprises, as shown in FIG. 5, a certain number of propellers, which are connected with one another in series and parallel combinations according to what will be said later.

The scheme is similar to that of FIG. 1, with elimination of the Voltage Transformer 9 and the Phase Regulator 10, which are intended as included in the Feeder 2 (identical to the Frequency Converter 2 of FIG. 1).

A Feeder 2 at two outlets 2a and 2b, connected at its inlet 2c to a power net at 50 Hz, supplies to all the apparatus:
from the first outlet 2a, for the generation of the magnetic fields, an alternating current [I=40 A], 20 MHz, at waves assumed as perfectly rectangular,
from the second outlet 2b, for the generation of the electric fields, an alternating voltage, isofrequential with the current of the first outlet 2a and with the same characteristics as regards the form of the waves.

The alternating voltage of the first outlet 2a must be such as to make circulate in the circuit of the propellers the intensity provided for the current.

The alternating voltage of the second outlet 2b must be such as to secure within the Treating Chamber 1 for the electric field strength E a number of V/cm sufficient to produce an efficient stretching of the molecules.

For the molecular polarization here considered there can be foreseen, as a minimum, some tens of V/cm. The employment of higher electric field strengths, in the order of the 1000 V/cm, can produce, in addition to a more efficient stretching of the molecules, a certain increase of the equivalent arm of dipolar electric moment, for further deformation of the molecule H₂O.

For the electronic polarization the electric field strength within the Treating Chamber must be very high (in the order of the tens of thousands of V/cm), since in such polarization the dipolar electric moment is proportional to the voltage applied.

Downstream the Feeder it is placed a Non-Inductive Resistance 3, that can be also absent.

Downstream the Non-Inductive Resistance 3 there is the complex of the propellers, the first only of which is shown in FIG. 5, indicated with 4. The propeller 4 consists of the following elements.
A winding 5 or inductor at turns in conducting material in which the electric current for the generation of the magnetic field circulates. The turns are “in air” (without magnetic nucleus). The axis of the winding lies along z, and the turns are at rectangular section of 3 cm along y and 5 cm along x. The winding 5 is divided into two parts, connected in series, each of which has the length along z of 6 cm and comprises 15 turns. The two parts are separated by a distance (“inductor interspacing”) of 2 cm.
A Treating Chamber 1, in correspondence of the inductor interspacing, of the section yz of 3×2 cm, in which the fluid flows.
A multiplicity of Resonance Condensers 6, interposed each at the connection between two subsequent turns 7 of the winding. Function of each of these Condensers is that of supplying a reactive voltage equal and of opposite sign (of capacity) with respect to the inductive voltage that is determined in the preceding turn, thus avoiding to make the same inductive voltage reach excessive values for all the inductor.
An Active Condenser 8, formed by two parallel plates (armature) laid in such a way as to produce an electric field directed along y through the Treating Chamber 1. The two plates are of the sizes, along x and z, respectively of 6 and 2 cm, and are spaced along y 4 cm. The voltage to be applied to the plates is that directly supplied by the Feeder 2 through the second outlet 2b.

It is utilized the number of molecules per cm³ calculated for the Basis Project 3.3428·10²².

The “equivalent velocity” of the schematic “equivalent electron” is obtained in the following way:

equivalent arm of dipolar electric moment δ=0.3852 Å=0.3852·10⁻¹⁰ m
frequency f=20 MHz=2·10⁷ s⁻¹
“equivalent velocity” v=4·δ·f=4·0.3852·10⁻¹⁰·2·10⁷=3.0816·10⁻³ m/s

The data relating to the first propeller are the following:
current I=40 A
frequency f=2·10⁷ Hz (wavelength λ=15 m)
angular velocity ω=2πf=6.28·2·10⁷ s⁻¹=1.256·10⁸ s⁻¹
calculation section of the turns 20 cm²−calculation length of 1 turn 20 cm
turn interaxis 0.4 cm
total number of turns 30−total length of the turns Lₛ=30×20=600 cm
length along z of each half of the inductor 6 cm
inductor interspacing 2 cm
total length along z of the propeller 14 cm
   For 1 turn

### Inductance L=1.25·10⁻⁶·1·20·10⁻⁴/0.004=0.625·10⁻⁶ H

### Reactance X_{L}=ω·L=1.256·10⁸·0.625·10⁻⁶=78.5 Ω

Inductive voltage V_{L}=X_{L}·I=78.5·40=3140 V
For 30 turns

### Induction B=1.25·10⁻⁶·30·40/0.14=10.71·10⁻³ T(Tesla)

Force on 1 molecule (e=1.602·10⁻¹⁹ electric charge of the electron in Coulomb)

F_{H2O}=e·B·v=1.602·10⁻¹⁹·10.71·10⁻³·3.0816·10⁻³=52.87·10⁻²⁵ N/molecule

Theoretical thrust on 1 propeller (5 cm of tube), referred to 1 cm² of tube section,

Σ₁=F_{H2O}·3.3428·10²²·5=52.87·10⁻²⁵·3.3428·10²²·5=0.8837 N/cm²

equal to 90.08 cm H₂O.

This thrust can be reduced through a coefficient, for example 0.7, to allow for the practical discrepancies of the waves of current from the exactly rectangular form and for other factors, among which the partial running-out of lines of the magnetic field from the Treating Chamber 1. It would be obtained, then, a thrust

(90.08·0.7)=63.06 cm H₂O.

In the case of propulsion of liquids at low volumetric throughputs (for example, 4 m³/h), as in this case, it is possible to subdivide the Treating Chamber 1 into a certain number of canals, to be connected in series with the same running way of the liquid. In the scheme of propeller considered it would be possible to arrange in the Treating Chamber several passages of one only Treating Tube.

With a Treating Tube having outside and inside diameters respectively of 10 and 8 mm the internal section would be 0.503 cm² and the velocity of water at 4 m³/h of 22.09 m/s. In order to reduce such velocity it is possible to vary the sizing of the propeller, or to subdivide the flow of the water into two parts to be connected in parallel. In this latter case, with 6 passages per propeller and (14·2)=28 propellers the theoretical thrust would be (14·6·0.06306)=5.2970 Kg/cm². Taking off from it the pressure losses of the water in the flow through the tubes, it would be left available a pressure head greater than 4 Kg/cm².

In each turn of a propeller 4 the inductance has been calculated at 0.625·10⁻⁶ H. The capacity of each Resonance Condenser 6 results

C=1/(ω²·L)=1/[(1.256·10⁸)²·0.625·10⁻⁶]=0.1014·10⁻⁹ F.

The Active Condenser 8 of the propeller 4 is fed, as already said, by a voltage directly supplied by the Feeder 2.

The propellers can be connected among one another in various ways, not shown, but in the following described.

In a first way, 5 propellers are placed on each other, in z-direction, with immediate contact between the windings. Several aggregates of 5 propellers are placed aside of each other, suitably spaced, in x-direction.

If the Treating Chambers of the propellers are not subdivided into canals there are 5 Treating Tubes, each of which runs rectilinearly through the propellers of the aggregates. The 5 Treating Tubes, then, can be connected with each other in parallel or in series. If the Treating Chamber of each propeller is subdivided into canals, in these there passes a tube crossing all the propellers or a part of these (if there are more tubes, to be put in parallel).

Another way of connection can be that of forming an aggregate by placing several propellers at contact with each other along a rectangular pattern, so that to produce along it a total magnetic field with flux lines completely closed in the inside of the turns, realizing an optimal utilization of the lines of the total magnetic field of the aggregate.

The windings of the inductors can be connected in series and parallel combinations.

The Active Condensers of the various propellers are connected with one another in parallel. It is necessary, however, to secure, eventually with suitable auxiliary devices, that in each propeller the phase relation between the vectors E of the electric field and B of the magnetic field through each Treating Chamber be such as to allow the working of the process according to FIG. 4.

1-15. (canceled)

16. Electromagnetic device for accelerating electrically neutral molecules of a (fluid or solid) substance, comprising:
at least a propeller (4), composed by:
at least one treating tube (14) in non-conducting material, into which the substance to be treated is introduced and flows from an inlet (11) to an outlet (12); and
one or more treating chambers (1), defined in the treating tube (14), in which an alternating voltage secures for the electric field strength E a value of V/cm sufficient to produce an efficient stretching of the molecules;
windings for the generation of magnetic fields, formed each by at least one turn (7) “in air”;
electromagnetic circuits that surround each treating chamber of the above treating tube exerting on the substance to be treated electromagnetic actions that push it axially utilizing the dipolar electric moment of the molecules,
said electromagnetic circuits defining:
alternating magnetic fields with vector “magnetic induction” B perpendicular to the direction of the thrust to be obtained, i.e. perpendicular to the axis of the treating tube (14);
alternating electric fields with vector “electric field strength” E perpendicular to both B and to the direction of the thrust;
a frequency converter (2) connected in inlet (2c) to a power net, and having a first outlet (2a) transmitting an alternating current at sinusoidal or rectangular waves for the generation of magnetic fields, this converter (2) having a second outlet (2b) for the generation of an alternating voltage, provided to produce the alternating electric field, said alternating voltage being isofrequential with the current of the first outlet and with the same characteristics in regard to the form of the wave;
a voltage transformer (9) for raising and regulating the voltage for the electric fields of the treating chambers (1);
a phase regulator (10), that regulates the phase relation between the electric field strength E of the electric field and the vector B of the magnetic field in the inside of each treating chamber (1);
process condensers (5), each formed by two parallel plates (armature) laid in such a way as to produce an electric field directed along y through each treating chamber (1), the two plates of each process condenser (5) being placed at the minimum possible distance from the walls of the treating tube (14), the process condensers being placed downstream the phase regulator (10);
wherein the device further has:
a non-inductive resistance (3) downstream the first outlet (2a) of the converter (2); and at least one resonance condenser (6);
wherein
the voltage transformer (9) is placed downstream the second outlet (2b) of the converter (2); and
the phase regulator (10) is placed downstream the voltage transformer (9).

17. Electromagnetic device for accelerating electrically neutral molecules of a (fluid or solid) substance, comprising:
at least a propeller (4) composed by
at least one treating tube (14) in non-conducting material, into which the substance to be treated is introduced and flows from an inlet (11) to an outlet (12); and
one or more treating chambers (1), defined in the treating tube (14);
windings for the generation of magnetic fields, formed each by at least one turn (7) “in air”;
electromagnetic circuits that surround each treating chamber (1) of the above treating tube (14) exerting on the substance to be treated electromagnetic actions that push it axially utilizing the dipolar electric moment of the molecules,
said electromagnetic circuits defining:
alternating magnetic fields with vector “magnetic induction” B perpendicular to the direction of the thrust to be obtained, i.e. perpendicular to the axis of the treating tube (14);
a “launcher”, for example, but not exclusively, of the type of that employed in the microwave ovens, oriented in such a way to launch Hertz waves oscillating in a direction perpendicular both to B and to the direction of the thrust, said Hertz waves being isofrequential to the magnetic field waves;
at least one resonance condenser (6).

18. Device according to claim 16, wherein more turns (7) are present, placed one above (along z) and one beneath each treating chamber (1), in these turns (7), connected in series and having axis lying along z, circulating the electric current for the generation of the magnetic field.

19. Device according to claim 16, wherein a multiplicity of resonance condensers (6) are present, each interposed between two subsequent turns (7), or two groups of turns, of each winding, these resonance condensers (6) supplying a reactive voltage equal and of opposite sign (of capacity) with respect to the inductive voltage that is determined in the turn, or in the group of turns, preceding; more resonance condensers (6) being insertable also within each turn.

20. Device according to claim 16, wherein there is a multiplicity of treating chambers (1) laid aligned along a treating tube (14).

21. Separator of isotopes of atoms in liquid or gas phase, having an electromagnetic device for accelerating electrically neutral molecules of a fluid, comprising:
a treating tube (14) in non-conducting material, into which the mixture of two or more components to be treated is introduced at an intermediate point;
a multiplicity of treating chambers (1) defined in the treating tube (14);
electromagnetic circuits that surround each treating chamber of the above treating tube exerting on the mixture to be treated electromagnetic actions that push the molecules of the components axially with Lorentz forces proportional to their dipolar electric moments, the components migrating each towards an end of the tube, from which they are extracted.

22. Device according to claim 16, wherein the treating tube (14) is helicoidal and forms a coil outside and inside which two windings of turns are laid, respectively “primary winding” and “secondary winding”: to the primary winding the current for the generation of the magnetic field is sent, while the secondary winding is left open at both ends; the magnetic field produced by the primary winding induces between two points in front of each other of the two windings an alternating voltage shifted in phase, with respect to the current sent to the primary winding, according to the Lenz rule; the Lorentz force on the fluid in the coil results directed tangentially to the same coil.

23. Motor for the linear propulsion or compression of fluids (liquids and gases) or of solids (in pieces, in powder or in suspension in liquids), the motor having an electromagnetic device for accelerating electrically neutral molecules of a substance, comprising:
a treating tube (14) in non-conducting material, into which the substance to be treated is introduced;
a multiplicity of treating chambers (1), defined in the treating tube (14);
electromagnetic circuits that surround each treating chamber (1) of the above treating tube exerting on the substance to be treated electromagnetic actions that push it axially utilizing the dipolar electric moment of the molecules,
said electromagnetic circuits defining:
alternating magnetic fields with vector “magnetic induction” B perpendicular to the direction of the thrust to be obtained, i.e. perpendicular to the axis of the treating tube (14);
a “launcher” oriented in such a way to launch Hertz waves oscillating in a direction perpendicular both to B and to the direction of the thrust, said Hertz waves being isofrequential to the magnetic field waves.

24. Generator of electricity fed by fluids under pressure, having an electromagnetic device for accelerating electrically neutral molecules of a fluid substance, comprising:
a treating tube (14) in non-conducting material, into which the substance to be treated is introduced;
electromagnetic circuits that surround the above treating tube exerting on the substance to be treated electromagnetic actions that push it axially utilizing the dipolar electric moment of the molecules.

25. Separator of chemical components in liquid or gas phase, having an electromagnetic device for accelerating electrically neutral molecules of a fluid, comprising:
a treating tube (14) in non-conducting material, into which the mixture of two or more components to be treated is introduced at an intermediate point;
a multiplicity of treating chambers (1) defined in the treating tube (14);
electromagnetic circuits that surround each treating chamber of the above treating tube exerting on the mixture to be treated electromagnetic actions that push the molecules of the components axially with Lorentz forces proportional to their dipolar electric moments, the components migrating each towards an end of the tube, from which they are extracted.

26. Flow indicator for fluids, having an electromagnetic device for accelerating electrically neutral molecules of a fluid, comprising:
a treating tube (14) in non-conducting material, into which the fluid to be treated is introduced;
electromagnetic circuits that surround the above treating tube exerting on the fluid to be treated electromagnetic actions that push it axially utilizing the dipolar electric moment of the molecules.

27. Rotatory electric motor without electric connections between stator and rotor, having an electromagnetic device for accelerating electrically neutral molecules of a fluid, comprising:
a treating tube (14) in non-conducting material, into which the fluid to be treated is introduced;
electromagnetic circuits that surround the above treating tube exerting on the fluid to be treated electromagnetic actions that push it axially utilizing the dipolar electric moment of the molecules,
said electromagnetic circuits defining:
an alternating magnetic field with vector “magnetic induction” B perpendicular to the direction of the thrust to be obtained, i.e. perpendicular to the axis of the treating tube (14);
an alternating electric field with vector “electric field strength” E perpendicular to both B and to the direction of the thrust.

28. Method for accelerating electrically neutral molecules of a (fluid or solid) substance, wherein a Lorentz force is exerted on the molecules utilizing their dipolar electric moment, pre-existent or induced by an external electromagnetic field, by subjecting the substance in a multiplicity of treating chambers (1) to the action of an alternating magnetic field with vector “magnetic induction” B perpendicular to the direction of the thrust to be obtained and, simultaneously, to Hertz waves oscillating in a direction perpendicular both to B and to the direction of the thrust.

29. Electromagnetic device according to claim 16, wherein there is a multiplicity of ferrite plates (8), forming the magnetic nucleus of each turn (7), for windings which are not with turns “in air”.

30. Device according to claim 17, wherein more turns (7) are present, placed one above (along z) and one beneath each treating chamber (1), in these turns (7), connected in series and having axis lying along z, circulating the electric current for the generation of the magnetic field.

31. Device according to claim 17, wherein a multiplicity of resonance condensers (6) are present, each interposed between two subsequent turns (7), or two groups of turns, of each winding, these resonance condensers (6) supplying a reactive voltage equal and of opposite sign (of capacity) with respect to the inductive voltage that is determined in the turn, or in the group of turns, preceding; more resonance condensers (6) being insertable also within each turn.

32. Device according to claim 17, wherein there is a multiplicity of treating chambers (1) laid aligned along a treating tube (14).

33. Electromagnetic device according to claim 17, wherein there is a multiplicity of ferrite plates (8), forming the magnetic nucleus of each turn (7), for windings which are not with turns “in air”.
